(19) United States
(12) Patent Application Publication
(10) Pub. No.: US 2009/0078368 A1
(43) Pub. Date: Mar. 26, 2009

(54) METHOD OF PRODUCING COPPER-CLAD LAMINATE, METHOD OF PRODUCING COVERLAY, AND METHOD OF PRODUCING FLEXIBLE PRINTED CIRCUIT BOARD

(75) Inventors: Shinya NISHIMURA, Sakura-shi (JP); Mitsuru Ueda, Meguro-ku (JP); Tomohito Ogura, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignees: Fujikura Ltd., Tokyo (JP); Tokyo Institute of Technology, Tokyo (JP)

(21) Appl. No.: 12/268,786

(22) Filed: Nov. 11, 2008

Related U.S. Application Data
(63) Continuation of application No. PCT/JP2007/059891, filed on May 14, 2007.

(30) Foreign Application Priority Data
May 12, 2006 (JP) 2006-134403
Aug. 22, 2006 (JP) 2006-225222

(51) Int. Cl. B32B 38/14; B29C 65/52; B29C 65/48

(52) U.S. Cl. 156/277; 156/60

(57) ABSTRACT

A method of producing a copper-clad laminate by laminating a copper foil on a polyimide layer, wherein the polyimide layer is produced by imidating a polyamide acid which is obtained by reacting one of an aromatic diacid anhydride and alicyclic diacid anhydride and one of an aliphatic diamine and alicyclic diamine, with an acid having a pKa of 3 to 5.

### CROSS REFERENCE TO RELATED APPLICATIONS

This is a continuation of Application PCT/JP2007/059891, filed May 14, 2007. The present application claims priority from Japanese Patent Application No. 2006-134403 filed on May 12, 2006, and Japanese Patent Application No. 2006-225222 filed on Aug. 22, 2006, the entire contents of all of which are incorporated herein by reference.

### TECHNICAL FIELD

The present invention relates to methods of producing a copper-clad laminate having a polyimide layer and a coverlay, and to a method of producing a flexible printed circuit board using these copper-clad laminate and coverlay.

### BACKGROUND

In general, a flexible printed circuit board has a structure in which a circuit pattern is formed on the copper foil of a copper-clad laminate, and a coverlay is bonded thereto so as to insulate and protect the circuit pattern. FIG. 1 is a lateral cross-sectional view showing an example thereof, and in FIG. 1, reference numeral 1 represents a copper-clad laminate, 2 represents a copper foil, 3 represents the base material of the copper-clad laminate, 4 represents a coverlay, 5 represents the base material of the coverlay, 6 represents an adhesive layer, and 7 represents a flexible printed circuit board.

The copper-clad laminate 1 used in the flexible printed circuit board 7 has a copper foil 2 laminated on the surface of one side (or both sides) of a base material 3, and a circuit pattern is formed on the copper foil 2 using a suitable method such as copper etching. As the base material 3, for example, a plastic film such as polyimide, polyethylene terephthalate, or polyethylene naphthalate is used.

The coverlay 4 used in the flexible printed circuit board 7 is made from a base material 5, an adhesive layer 6 obtained by applying a thermosetting adhesive on the surface of one side of the base material 5, and a release liner or a release film (carrier film) attached on the adhesive layer 6. As the base material 5, for example, a plastic film such as polyimide, polyethylene terephthalate, or polyethylene naphthalate is used.

In order that the coverlay 4 is bonded to the copper-clad laminate 1, the copper-clad laminate 1 is covered with the coverlay 4 in which the release liner or release film has been peeled off, and the assembly is heat treated under predetermined conditions. The adhesive layer 6 thermally set through the heat treatment, so that the circuit pattern is insulated and protected, and at the same time, the coverlay 4 is adhered to the copper-clad laminate 1. Thus, the flexible printed circuit board 7 is obtained.

In addition, the coverlay 4 needs to be processed to have the external appearance and the openings in accordance with the shape of the flexible printed circuit board 7. The external appearance and the openings can be obtained by processing the coverlay 4 having the release liner or release film still attached thereon using a mold or the like, before the coverlay is bonded to the copper-clad laminate 1. Alternatively, the external appearance and the openings are processed in the desired place of the coverlay 4 by scanning a laser, after adhering an unprocessed coverlay 4 to the copper-clad laminate 1.

As for the base material 3 of the copper-clad laminate 1 and the base material 5 of the coverlay 4 in the flexible printed circuit board 7 as described above, polyimide is particularly preferred. Polyimide is obtained by subjecting tetracarboxylic acid dianhydride and a diamine compound to a polycondensation reaction to obtain a polyamide acid, and further subjecting the product to an imidation reaction. Polyimide is a polymeric material which has very high thermal stability, and is useful as, for example, an electrically insulating material, a heat-resistant coating film material, or a high performance printed circuit board material.

Moreover, polyimides obtained using aromatic diacid anhydrides or alicyclic diacid anhydrides as the tetracarboxylic acid anhydride and using aliphatic diamines or alicyclic diamines as the diamine compound, are expected to have excellent properties such as a low dielectric constant, high transparency, and high heat resistance. Among these, examples of alicyclic polyimides which are obtained by using alicyclic diacid anhydrides are disclosed in, for example, Patent Documents 1 to 4.

[Patent Document 1] JP-A No. 2002-316990

[Patent Document 2] JP-A No. 2002-256074

[Patent Document 3] JP-A No. 2002-161136

[Patent Document 4] JP-A No. 2003-155342

[Non-Patent Document 1] M. Hasegawa; High Perform. Polym., 13, S93-S106 (2001)

[Non-Patent Document 2] Japan Polyimide Research Group; Recent Polyimides—Fundamentals and Applications, P387-P407 (2002)

### SUMMARY

Since it was very difficult to synthesize alicyclic polyamide acids, practically no flexible printed circuit boards employing alicyclic polyimides have been manufactured hitherto (see Non-Patent Documents 1 and 2). The reasons are conceived to be as follows.

In the reaction between an aromatic diacid anhydride and an aromatic diamine, since both of the pKa values of the aromatic diacid anhydride and the aromatic diamine are from 3 to 5, nucleophilicity of the aromatic diamine is maintained favorably, and then the two compounds can be copolymerized to synthesize a polyamide acid. Furthermore, the product can be dehydrated and cyclized by heating, and then subjected to an imidation reaction, and as a result, a high molecular weight polyimide is synthesized.

However, in the reaction between an aromatic diacid anhydride or alicyclic diacid anhydride (formula 1), and an aliphatic diamine or alicyclic diamine (formula 2), since both of the pKa values of the raw material aliphatic diamine and alicyclic diamine (formula 2) are approximately 11 with strong basicity, the ionic bonding ability becomes stronger, and the nucleophilicity of the aliphatic diamine or alicyclic diamine (formula 2) becomes weaker. For this reason, the associated reaction generates heat and rapidly forms an amide acid salt (formula 3), and the resulting salt becomes insoluble in the solvent and precipitates out. Therefore, synthesis of a high molecular weight polyamide acid (formula 4) was difficult, and as a result, synthesis of a high molecular weight polyimide (formula 5) was also difficult.

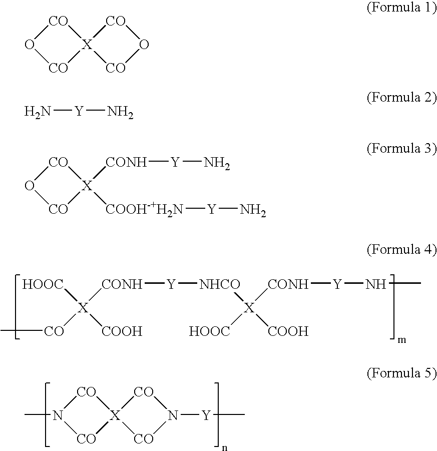

Meanwhile, since conventional general-purpose polyimides have thermal expansion coefficients as high as about 22 to 25 ppm/K, when producing a flexible printed circuit board using the copper-clad laminate and coverlay employing such polyimides as the base materials, the printed board may have problems in dimensional stability, and there is a possibility of having defective products.

Furthermore, with regard to conventional general-purpose polyimides, for example, whole aromatic polyimides, it is difficult to decrease the dielectric constant because of the intramolecular orientation and intermolecular orientation.

Under the circumstances as described above, it is an object of the present invention to provide a flexible printed circuit board which employs an alicyclic polyimide having excellent dimensional stability and good transparency.

In order to achieve the above-described object, the invention provides a method of producing a copper-clad laminate by laminating a copper foil on a polyimide layer, wherein the polyimide layer is produced by imidating a polyamide acid which is obtained by allowing an aromatic diacid anhydride or alicyclic diacid anhydride, an aliphatic diamine or alicyclic diamine, and an acid having a pKa of 3 to 5 to react.

The invention also provides a method of producing a coverlay by laminating an adhesive layer on a polyimide layer, wherein the polyimide layer is produced by imidating a polyamide acid which is obtained by allowing an aromatic diacid anhydride or alicyclic diacid anhydride, an aliphatic diamine or alicyclic diamine, and an acid having a pKa of 3 to 5 to react.

The invention also provides a method of producing a flexible printed circuit board, comprising steps of forming a circuit pattern on the copper foil of the copper-clad laminate obtained by the method of producing a copper-clad laminate, and then bonding the coverlay obtained by the method of producing a coverlay, to the copper-clad laminate with the adhesive layer interposed therebetween.

According to examplary embodiments, an aromatic diacid anhydride or alicyclic diacid anhydride, and an aliphatic diamine or alicyclic diamine can be copolymerized to a high molecular weight polymer within a short time, an alicyclic polyimide having excellent dimensional stability and good transparency can be produced, and a copper-clad laminate, a coverlay and a flexible printed circuit board employing the alicyclic polyimide can be provided.

Furthermore, when an alicyclic polyimide having excellent dimensional stability and maintaining transparency is used, the fraction defective is decreased in the production of copper-clad laminates, coverlays and flexible printed circuit boards, and early discovery of defective products is made possible. Thus, an improvement of the yield and an improvement of the product quality can be attempted.

### BRIEF DESCRIPTION OF THE DRAWINGS

FIG. 1 is a lateral cross-sectional view illustrating the basic structure of a flexible printed circuit board.

FIG. 2A is a lateral cross-sectional view showing an example of the method of producing a flexible printed circuit board of the present invention in the order of processes.

FIG. 2B is a lateral cross-sectional view showing an example of the method of producing a flexible printed circuit board of the invention in the order of processes.

FIG. 2C is a lateral cross-sectional view showing an example of the method of producing a flexible printed circuit board of the invention in the order of processes.

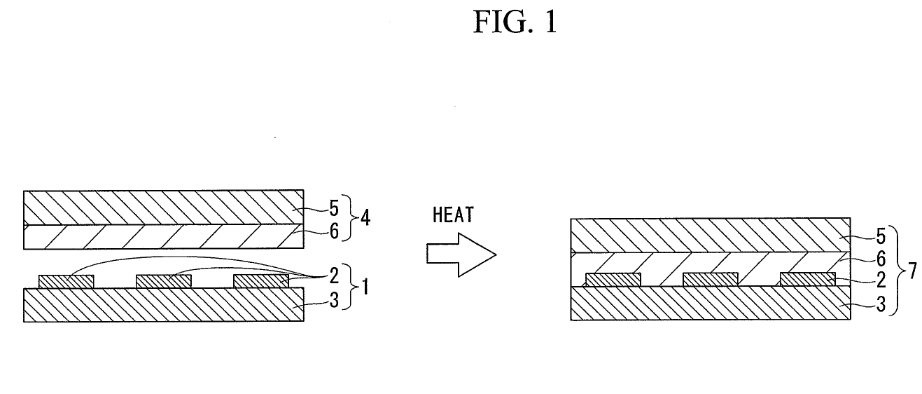

### REFERENCE NUMERALS

1, 11: COPPER-CLAD LAMINATE
2, 12: COPPER FOIL
3, 5: BASE MATERIAL
4, 14: COVERLAY
6, 16: ADHESIVE LAYER
7, 20: FLEXIBLE PRINTED CIRCUIT BOARD
13, 15: POLYIMIDE LAYER
17: RELEASE FILM
18: OPEN WINDOW PROCESSING PART

### DETAILED DESCRIPTION OF EXEMPLARY EMBODIMENTS OF THE INVENTION

The diacid anhydride used in the production method of exemplary embodiments of the invention is an aromatic diacid anhydride or an alicyclic diacid anhydride (formula 1). An aromatic diacid anhydride or alicyclic diacid anhydride having a pKa of 3 to 5 can be suitably used.

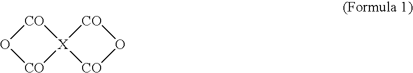

As the aromatic diacid anhydride, there may be mentioned compounds represented by above formula 1 in which X represents the following formulae 6 to 8.

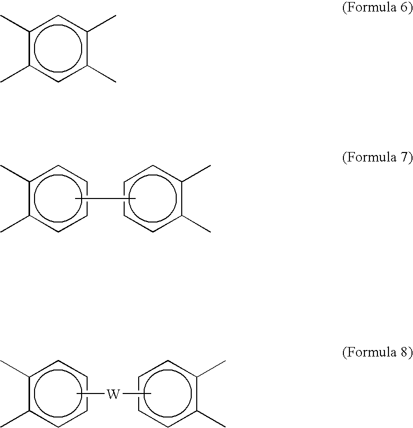

For example, pyromellitic dianhydride, 3,3′,4,4′-biphenyltetracarboxylic dianhydride, 2,3,3′,4′-biphenyltetracarboxylic dianhydride, 3,3′,4,4′-benzophenonetetracarboxylic dianhydride, 3,3′,4,4′-diphenyl ether tetracarboxylic dianhydride, 3,3′,4,4′-diphenylmethanetetracarboxylic dianhydride, 2,2-bis(3,4-dicarboxyphenyl)propane dianhydride, 2,2-bis(3,4-dicarboxyphenyl)hexafluoropropane dianhydride, 3,3′,4,4′-diphenylsulfonetetracarboxylic dianhydride, 2,2-bis[4-(3,4-dicarboxyphenoxy)phenyl]propane dianhydride, 4,4′-bis(3,4-dicarboxyphenoxy)diphenyl ether dianhydride, 4,4′-bis(3,4-dicarboxyphenoxy)diphenyl sulfide dianhydride, 4,4′-bis(3,4-dicarboxyphenoxy)benzophenone dianhydride, 4,4′-bis(3,4-dicarboxyphenoxy)diphenylsulfone dianhydride, 2,2-bis[4-(2,3-dicarboxyphenoxy)phenyl]propane dianhydride, 4,4′-bis(2,3-dicarboxyphenoxy)diphenyl ether dianhydride, 4,4′-bis(2,3-dicarboxyphenoxy)diphenyl sulfide dianhydride, 4,4′-bis(2,3-dicarboxyphenoxy)benzophenone dianhydride, 4,4′-bis(2,3-dicarboxyphenoxy)diphenylsulfone dianhydride, 4-(2,3-dicarboxyphenoxy)-4′-(3,4-dicarboxyphenoxy)diphenyl-2,2-propane dianhydride, 4-(2,3-dicarboxyphenoxy)-4′-(3,4-dicarboxyphenoxy)diphenyl ether dianhydride, 4-(2,3-dicarboxyphenoxy)-4′-(3,4-dicarboxyphenoxy)diphenyl sulfide dianhydride, 4-(2,3-dicarboxyphenoxy)-4′-(3,4-dicarboxyphenoxy)benzophenone dianhydride, or 4-(2,3-dicarboxyphenoxy)-4′-(3,4-dicarboxyphenoxy)diphenylsulfone dianhydride may be mentioned.

As the alicyclic diacid anhydride, for example, there may be mentioned monocyclic aliphatic diacid anhydrides such as cyclobutanetetracarboxylic type diacid anhydrides, or polycyclic aliphatic diacid anhydrides (formula 9).

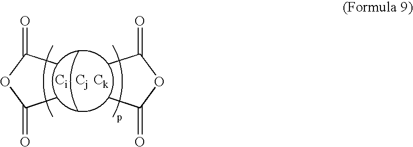

The repeating unit having a cyclic aliphatic structure of the polycyclic aliphatic diacid anhydride (represented by formula 9) is a cyclic structure in which two carbon atoms are bridged by Cᵢ or Cₖ, which represent two identical or different alkylene groups or alkenylene groups having 2 to 7 carbon atoms; and Cⱼ, which represents a bond, an alkylene group or alkenylene group having 0 to 2 carbon atoms (for example, a single bond, a double bond, a methylene group, an ethylene group, an ethenylene group) as bridging groups. Specific examples of the polycyclic aliphatic diacid anhydride (formula 9) include bicyclo[2.2.2]oct-7-ene-2,3,5,6-tetracarboxylic dianhydride, or pentacyclo [8.2.1.1^{4,7}.0^{2,9}.0^{3,8}]tetradecane-5,6,11,12-tetracarboxylic acid dianhydride.

For example, an alicyclic polyamide acid (formula 10) can be synthesized from a polycyclic aliphatic diacid anhydride (formula 9), and an aliphatic diamine or alicyclic diamine (formula 2) by the production method of the invention, and when the alicyclic polyamide acid (formula 10) is cyclized and imidated, an alicyclic polyimide (formula 11) can be synthesized.

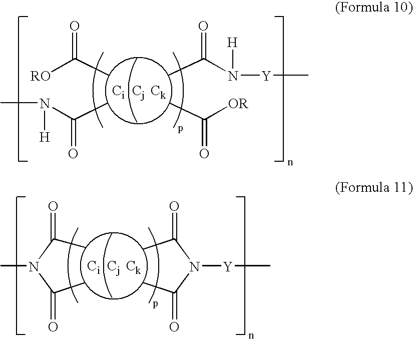

Y is a cyclic aliphatic group, R is hydrogen atom or an acrylate group, Ci and Ck are each a substituted alkylene group or alkenylene group having 2 to 7 carbon atoms, Cj is a bond, an alkylene group or alkenylene group having 0 to 2 carbon atoms (for example, a single bond, a double bond, a methylene group, an ethylene group, an ethenylene group), p is an integer from 1 to 8, and n is an integer of 1 or greater.

As the alicyclic diacid anhydride, spiro-diacid anhydrides (formula 12) may be further mentioned.

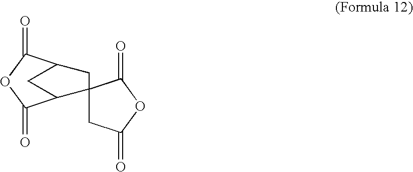

Spiro-diacid anhydrides (formula 12) include [1SR,5RS,6SR]-3-oxabicyclo[3.2.1]octane-2,4-dione-6-spiro-3′-(tetrahydrofuran-2′,5′-dione), [1S,5R,6S]-3-oxabicyclo[3.2.1]octane-2,4-dione-6-spiro-3′-tetrahydrofuran-2′,5′-dione, and [1R,5S,6R]-3-oxabicyclo[3.2.1]octane-2,4-dione-6-spiro-3′-tetrahydrofuran-2′,5′-dione. These compounds may have optical activity.

The diamine compound used in exemplary embodiments of the invention is an aliphatic diamine or an alicyclic diamine (formula 2). Although the diamine compound is an aliphatic diamine or alicyclic diamine having a pKa of 10 to 11, since the compound is reacted with a weak acid having a pKa of 3 to 5, even if a salt is formed, the salt maintains a nucleophilicity equivalent to that of an aromatic amine, and can be dissolved in a solvent. Therefore, the diamine compound can be suitably copolymerized with an aromatic diacid anhydride or an alicyclic diacid anhydride.

H₂N—Y—NH₂ (Formula 2)

As the aliphatic diamine, for example, there may be mentioned ethylenediamine, propylenediamine, trimethylenediamine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy)ethane, or bis(3-aminopropyl)sulfide.

For the alicyclic diamine (formula 2), Y is a cyclic aliphatic group, and for example, there may be mentioned a cycloalkylene group having 3 to 8 carbon atoms, a cycloalkenylene group having 3 to 8 carbon atoms, a cycloalkynylene group having 3 to 8 carbon atoms, a norbornenylene group, a decalinylene group, an adamantanylene group, or a cubanylene group.

As the alicyclic diamine, for example, there may be mentioned diaminocycloalkane, diaminocycloalkene, diaminocycloalkyne, diaminonorbornene, diaminodecaline, diaminoadamantane, or diaminocubane, and specific examples include 1,4-cyclohexanediamine, bis-(4-aminocyclohexyl)methane, or 1,3-diaminoadamantane.

It is preferable that the aliphatic diamine or alicyclic diamine be subjected to an acid having a pKa of 3 to 5, and then the resultant be reacted with an aromatic diacid anhydride or alicyclic diacid anhydride. The aliphatic diamine or alicyclic diamine is strongly basic, with the pKa being from 10 to 11, but when the diamine is reacted with an acid having a pKa of 3 to 5 to form a salt, the diamine attains nucleophilicity that is equivalent to that of an aromatic amine. Thus, the diamine can be favorably subjected to a copolymerization reaction with an aromatic diacid anhydride or alicyclic diacid anhydride.

As the acid having a pKa of 3 to 5 which is used in the production method of exemplary embodiments of the present invention, organic acids or inorganic acids may be mentioned, and the organic acids may be exemplified by formic acid (pKa=3.6), acetic acid (pKa=4.7), propionic acid (pKa=4.9), or butyric acid (pKa=4.8), while the inorganic acids may be exemplified by phosphoric acid (pKa=4.2), or carbonic acid (pKa=4.9). The acid having a pKa of 3 to 5 which is used in the production method of exemplary embodiments of the invention, is preferably an organic acid.

The acid having a pKa of 3 to 5 which is used in the production method of the present invention is preferably an acid having a low molecular weight, so that the acid can be volatilized and removed by heating at the time of imidation reaction.

In the method of producing a copper-clad laminate of the invention, the polyamide acid obtained by the above-described method for synthesizing a polyamide acid, is subjected to an imidation reaction to produce polyimide in a sheet form or in a film form (polyimide layer), and a copper foil is laminated on the polyimide layer to obtain a copper-clad laminate.

In the method of producing a coverlay of the invention, an adhesive layer is laminated on the polyimide layer to obtain a coverlay.

Furthermore, in the method of producing a flexible printed circuit board of the invention, the copper-clad laminate obtained after the formation of a circuit pattern is bonded with the coverlay to obtain a flexible printed circuit board.

As for the conditions for the imidation reaction of the polyamide acid, for example, the reaction can be performed by heating at 260° C. to 400° C. under reduced pressure. As for the method of producing a polyimide layer in a sheet form or in a film form by imidating polyamide acid, any of conventionally known methods of producing various polyimide sheets or polyimide films is applicable.

In the method of producing a copper-clad laminate of the present invention, the process of laminating a copper foil on the polyimide layer may use a method of superimposing a copper foil onto the polyimide layer and directly heat pressing the assembly; a method of superimposing the polyimide layer and a copper foil with an appropriate thermosetting adhesive interposed therebetween, and heat pressing the members to adhere; or a method of coating a polyamide acid solution on a copper foil to an appropriate thickness and then heating the assembly at 260° C. to 400° C. under reduced pressure to laminate the polyimide layer and a copper foil.

In the method of producing a coverlay of the invention, the process of laminating an adhesive layer on the polyimide layer is carried out in the same manner as in conventional methods of producing a coverlay by applying a thermosetting adhesive on the polyimide layer. As the adhesive used in the adhesive layer 16, an adhesive can be appropriately selected from various commercially available thermosetting adhesives or adhesive sheets that are conventionally known in the fields of flexible printed circuit board production and the like. It is preferable that the resulting coverlay be attached to a base material formed from a plastic film through an adhesive, in order to enhance the handlability. The surface of the opposite side of the adhesive layer in the coverlay, has a carrier film detachably adhered. In addition, the material of the plastic film used as the base material of the carrier film is not particularly limited.

In the method of producing a flexible printed circuit board of the present invention, the copper-clad laminate having an alicyclic polyimide layer obtained by the method of producing a copper-clad laminate of the invention, and the coverlay having an alicyclic polyimide layer obtained by the method of producing a coverlay of the invention, are used to manufacture a flexible printed circuit board.

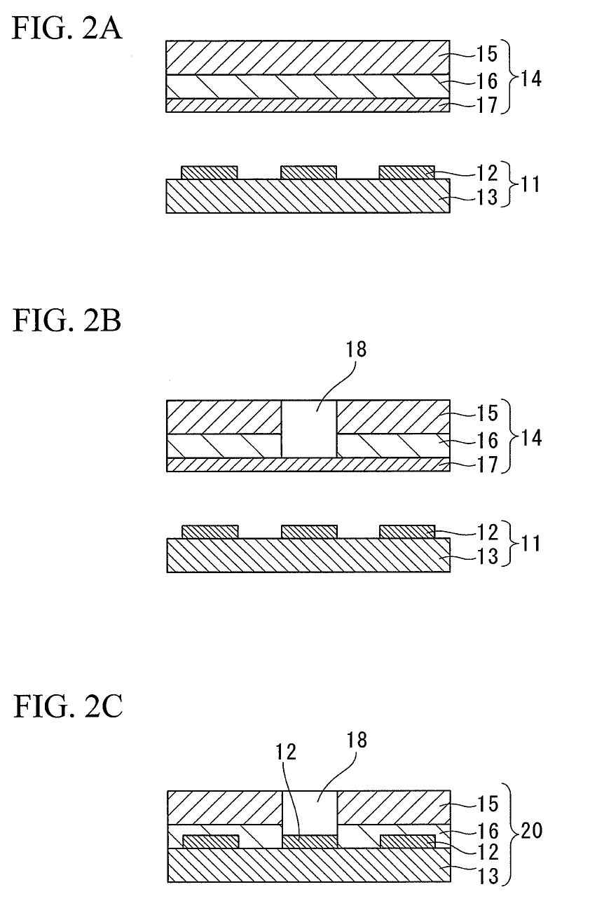

FIG. 2A to FIG. 2C are lateral cross-sectional views showing examples of the method of producing a flexible printed circuit board of the invention in the order of processes. In FIG. 2A to FIG. 2C, reference numeral 11 represents a copper-clad laminate, 12 represents a copper foil (circuit pattern), 13 represents the polyimide layer of the copper-clad laminate, 14 represents a coverlay, 15 represents the polyimide layer of the coverlay, 16 represents an adhesive layer, 17 represents a release film, 18 represents an open window processing part (outer diameter, opening), and 20 represents a flexible printed circuit board.

In the current example, the copper-clad laminate 11 having an alicyclic polyimide layer 13 obtained by the method of producing a copper-clad laminate of the invention, and the coverlay 14 having an alicyclic polyimide layer 15 obtained by the method of producing a coverlay of the invention, are used, and first, a circuit pattern is formed on the copper foil 12 of the copper-clad laminate 11 by removing the copper foil parts other than the necessary circuit pattern using an appropriate method such as copper etching.

As shown in FIG. 2A, the copper-clad laminate 11 having a circuit pattern formed, and the coverlay 14 are provided, and then as shown in FIG. 2B, the coverlay 14 having a peel-off film 17 still adhered is processed to form the open window processing part 18.

Subsequently, the peel-off film 17 of the coverlay 14 is peeled off, and as shown in FIG. 2C, the coverlay 14 is covered and bonded on the copper-clad laminate 11.

Subsequently, the copper-clad laminate 11 having the coverlay 14 superimposed thereon is subjected to heat pressing, so that the adhesive layer 16 of the coverlay 14 is thermally cured to laminate the coverlay 14 on the copper-clad laminate 11. Thereby, the flexible printed circuit board 20 is obtained.

In addition, the open window processing can be carried out by a method of processing the coverlay 14 with a release film 17 still adhered thereon, using a mold or the like, before the coverlay 14 is bonded to the copper-clad laminate 11; as well as, for example, by a method of bonding an unprocessed coverlay 14 to the copper-clad laminate 11 by adhesion, and then processing the coverlay 14 by scanning a laser beam to the desired place.

According to exemplary embodiments of the invention, an aromatic diacid anhydride or alicyclic diacid anhydride, and an aliphatic diamine or alicyclic diamine can be copolymerized to a high molecular weight polymer within a short time, and an alicyclic polyimide having excellent dimensional stability and good transparency can be produced, so that a copper-clad laminate, a coverlay and a flexible printed circuit board using the alicyclic polyimide can be provided.

Furthermore, when an alicyclic polyimide having excellent dimensional stability and maintaining transparency is used, the fraction defective is reduced in the production of copper-clad laminates, coverlays and flexible printed circuit boards. Also, since the early discovery of defective products is made possible, an improvement of the yield and an improvement of the product quality can be attempted.

### EXAMPLES

### Production of Polyamide Acid

A polyamide acid was synthesized by the following techniques, using a combination of 3,3′,4,4′-biphenyltetracarboxylic acid dianhydride (BPDA), 1,2-cyclohexanediamine (CHDA) and acetic acid.

(1) 3 mmol of 1,2-cyclohexanediamine (CHDA) were added to a pear-shaped flask, and a stirrer tip was introduced therein. Furthermore, the pear-shaped flask was attached with a reflux tube, and immersed in an oil bath. Because the compound easily absorbed the moisture in air, the operation was carried out quickly. At this time, the temperature of the oil bath was still room temperature.

(2) A three-way cock is attached to the top of the reflux tube, and the flask is purged with nitrogen. After the nitrogen purging, the flask is maintained with a nitrogen flow throughout the process.

(3) About 8 ml of dimethylacetamide (DMAC) was added through the top of the three-way cock. After the addition, the system was sufficiently stirred.

(4) The oil bath was heated to 90° C. to sufficiently dissolve CHDA in DMAC.

(5) When all of CHDA dissolved in DMAC, the system was removed from the oil bath, and was cooled to room temperature.

(6) To the system of CHDA+DMAC cooled to room temperature, 6 mmol of acetic acid were added. When the mixture was sufficiently stirred, an acetic acid salt of CHDA was produced as a white precipitate.

(7) After the stirring, 3 mmol of 3,3′,4,4′-biphenyltetracarboxylic acid dianhydride (BPDA) were added thereto, and the mixture was stirred. At that time, since reaction heat would be generated, the flask was kept water-cooled (particularly intense cooling, for example, cooling with ice water, is unnecessary).

(8) In two hours of reaction time, the solution became transparent, with the viscosity increasing, and the proceeding state of the copolymerization reaction was monitored.

Production of polyamide acid was confirmed by IR measurement. The inherent viscosity of a DMAC solution of the resulting polyamide acid was measured, and was found to be 2.29 dl/g.

[Production of Polyimide]

A DMAC solution of the obtained polyamide acid was cast and heated at 300° C., to obtain an insoluble film. Generation of polyimide was confirmed by IR measurement. A polyimide film having a thickness of 25 μm was produced, and this was used as the Example.

### COMPARATIVE EXAMPLE

A polyimide film manufactured by Toray-DuPont Co., Ltd. (thickness: 25 μm, product name: Kapton EN) was used as the Comparative Example.

[Comparison Test]

The polyimide film of the Example and the polyimide film of the Comparative Example were used to perform measurement tests for the following respective items.

The results are described in Table 1.

<Dielectric Constant>

The dielectric constant was measured by a cavity resonator perturbation method.

<Thermal Expansion Coefficient>

The coefficient was measured by a TMA (Thermal Mechanical Analyzer) at a temperature in the range of 50 to 200° C. at a temperature increase rate of 10° C./min.

<Water Content>

The water content was measured after leaving the films to stand for 96 hours at 40° C. and 90% RH, by a Carl-Fischer coulometric titration method.

<Thermal Shrinkage>

The thermal shrinkage was measured according to the description of JIS C6471 section 9.

<Humidity Expansion Coefficient>

Polyimide films having a size of 250 mm×250 mm were left to stand for 96 hours at normal temperature under a reduced pressure of 1 kPa or less, and then left to stand for 96 hours at normal temperature and 90% RH. Then, the dimensional measurements of the films were taken.

TABLE 1

| Item | Example | Comparative Example |
|---|---|---|
| Dielectric constant ∈ | 2.8 | 3.5 |
| (~10 GHz) | | |
| Thermal expansion | 20 or less | 22 to 25 |
| coefficient (ppm/K) | | |
| Water content (%) | 2.9 or less | 2.9 |
| Thermal shrinkage (%) | 0.01 or less | 0.01 to 0.1 |
| Humidity expansion | 2 or less | 10 to 20 |
| coefficient (ppm/RH %) | | |

From the results of Table 1, it can be seen that the polyimide film of Example has lower dielectric constant, thermal expansion coefficient, water content, thermal shrinkage and humidity expansion coefficient than those of the polyimide film of Comparative Example, and has excellent shape stability.

[Production of Copper-Clad Laminate]

A polyamide acid produced in the same manner as in the Example by the method described in the section [Production of polyamide acid], was applied on a rolled copper foil having a thickness of 18 μm, and the assembly was heated to 350° C. as a maximum temperature under reduced pressure, to form a polyimide layer with a thickness of 25 μm on the copper foil. Thus, a copper-clad laminate was produced.

[Production of Coverlay]

A polyimide film having a thickness of 25 μm was produced in the same manner as in the Example, and a thermosetting epoxy resin (uncured, includes a solvent) was applied thereon. The solvent was volatilized to form an adhesive layer having a thickness of 25 μm.

[Production of Flexible Printed Circuit Board]

The copper foil of a copper-clad laminate (CCL) obtained as described in the above was processed to remove unnecessary parts by an etching method so as to form a predetermined circuit pattern. Thereafter, the terminal parts were bonded to a coverlay (CL) processed to have open windows, and the assembly was heated and pressed by heat pressing. The thermosetting adhesive layer was cured, and thus a flexible printed circuit board (FPC) was produced.

Since the polyimide layers of the copper-clad laminate and coverlay have excellent transparency and excellent shape stability, generation of defective products hardly occurred in the method of producing a flexible printed circuit board, and inspection of defective products was easy. In fact, when one thousand flexible printed circuit boards were produced, only 0.5% or less were found to be defective.

What is claimed is:

1. A method of producing a copper-clad laminate, comprising a step of laminating a copper foil on a polyimide layer,
wherein the polyimide layer is produced by imidating a polyamide acid obtained by allowing an aromatic diacid anhydride or alicyclic diacid anhydride, an aliphatic diamine or alicyclic diamine, and an acid having a pKa of 3 to 5 to react.

2. The method of producing a copper-clad laminate according to claim 1, wherein the polyamide acid is obtained by subjecting an aliphatic diamine or alicyclic diamine to an acid having a pKa of 3 to 5, and then reacting the resultant with an aromatic diacid anhydride or alicyclic diacid anhydride.

3. The method of producing a copper-clad laminate according to claim 1, wherein the acid having a pKa of 3 to 5 is an acid having a low molecular weight.

4. The method of producing a copper-clad laminate according to claim 1, wherein the acid having a pKa of 3 to 5 is an organic acid.

5. The method of producing a copper-clad laminate according to claim 4, wherein the organic acid is selected from the group consisting of formic acid, acetic acid, propionic acid, and butyric acid.

6. A method of producing a coverlay, comprising a step of laminating an adhesive layer on a polyimide layer,
wherein the polyimide layer is produced by imidating a polyamide acid obtained by allowing an aromatic diacid anhydride or alicyclic diacid anhydride, an aliphatic diamine or alicyclic diamine, and an acid having a pKa of 3 to 5 to react.

7. The method of producing a coverlay according to claim 6, wherein the polyamide acid is obtained by subjecting an aliphatic diamine or alicyclic diamine to an acid having a pKa of 3 to 5, and then reacting the resultant with an aromatic diacid anhydride or alicyclic diacid anhydride.

8. The method of producing a coverlay according to claim 6 or 7, wherein the acid having a pKa of 3 to 5 is an acid having a low molecular weight.

9. The method of producing a coverlay according to claim 6, wherein the acid having a pKa of 3 to 5 is an organic acid.

10. The method of producing a coverlay according to claim 9, wherein the organic acid is selected from the group consisting of formic acid, acetic acid, propionic acid, and butyric acid.

11. A method of producing a flexible printed circuit board, comprising steps of forming a circuit pattern on a copper foil of a copper-clad laminate, and then bonding the copper-clad laminate to a coverlay obtained by the method according to claim 6 with an adhesive layer interposed therebetween,
wherein the copper-clad laminate is obtained by laminating a copper foil on a polyimide layer, and the polyimide layer is produced by imidating a polyamide acid obtained by allowing an aromatic diacid anhydride or alicyclic diacid anhydride, an aliphatic diamine or alicyclic diamine, and an acid having a pKa of 3 to 5 to react.
